(19) United States
(12) Patent Application Publication
(10) Pub. No.: US 2015/0358859 A1
(43) Pub. Date: Dec. 10, 2015

(54) APPARATUS AND METHODS FOR REDUCING ROUND TRIP TIME DELAY OF REVERSE LINK TRANSMISSION

(71) Applicant: QUALCOMM INCORPORATED, SAN DIEGO, CA (US)

(72) Inventors: Meric Emre Uzunoglu, Solana Beach, CA (US); Jun Hu, San Diego, CA (US); Pavan C. Kaivaram, San Diego, CA (US); Kevin S. Seltmann, Carlsbad, CA (US); Ravindra Mahendrakumar Garach, Santa Clara, CA (US); Ammar Taiyebi Kitabi, San Diego, CA (US); Huang Lou, San Diego, CA (US); Rashid Ahmed Akbar Attar, San Diego, CA (US)

(21) Appl. No.: 14/298,065

(22) Filed: Jun. 6, 2014

(51) Int. Cl. H04W 28/22; H04W 52/14; H04W 52/16

(52) U.S. Cl. CPC H04W 28/22; H04W 52/16; H04W 52/146; H04W 88/02

(57) ABSTRACT

Aspects of the present disclosure can improve the round trip time delay of reverse link transmissions of an access terminal. The access terminal determines a first traffic-to-pilot power (T2P) ratio after a session negotiation. Then, the access terminal determines a second T2P ratio of a first subpacket of a physical layer packet, wherein the second T2P ratio may be boosted relative to the first T2P ratio. The access terminal transmits the at least one subpacket at the second T2P ratio utilizing a reverse link. Therefore, the physical layer packet may be early terminated, and round trip time delay of the reverse link may be reduced.

### TECHNICAL FIELD

The following relates generally to wireless communication, and more specifically, to round trip time delay improvements of reverse link transmission and similar methods.

### BACKGROUND

Wireless communication networks are widely deployed to provide various communication services such as telephony, video, data, messaging, broadcasts, and so on. These networks, which are usually multiple access networks, support communications for multiple users by sharing the available network resources. One example of a wireless communication network is CDMA2000, which uses Code Division Multiple Access (CDMA) channels to send voice and data between access terminals and access network. CDMA2000 is a Third Generation Partnership Project (3GPP2) standard and includes a number of standards such as 1x and EV-DO, which stands for “Evolution Data Optimized.” EV-DO networks provide high rate packet-data service (e.g., Voice over IP (VoIP) service) to access terminals using a combination of time-division multiplexing (TDM) on the forward link (from the access network to access terminals) and CDMA technology on the reverse link (from access terminals to the access network).

In EV-DO, Hybrid Automatic Repeat Request (HARQ) is implemented for reverse link transmissions. HARQ is a packet acknowledgment mechanism that increases data reliability by enabling retransmissions of failed packets (or retransmission of portions of those packets). In EV-DO, the reverse link packet transmissions are staggered in time, to allow the access network to demodulate and decode the reverse link packets and then transmit an acknowledgement to the access terminal, indicating whether or not the transmitted packet was decoded.

As the demand for mobile broadband access continues to increase, research and development continue to advance the CDMA2000 technologies not only to meet the growing demand for mobile broadband access, but to advance and enhance the user experience with mobile communications.

### BRIEF SUMMARY OF SOME EXAMPLES

As mentioned above, the technology discussed in this specification relates to wireless communication devices and methods. Some aspects of the present disclosure, as discussed in more detail below, may improve the round trip time delay of reverse link transmissions.

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

One aspect of the present disclosure provides a method of wireless communication operable at an access terminal. The access terminal determines a first traffic-to-pilot power (T2P) ratio after a session negotiation. The access terminal further determines a second T2P ratio of at least one subpacket of a packet, and the second T2P ratio is boosted relative to the first T2P ratio. Then, the access terminal transmits the at least one subpacket at the second T2P ratio utilizing a reverse link.

Another aspect of the present disclosure provides an access terminal for wireless communication. The access terminal includes means for determining a first traffic-to-pilot power (T2P) ratio after a session negotiation. The access terminal further includes means for determining a second T2P ratio of least one subpacket of a packet, and the second T2P ratio is boosted relative to the first T2P ratio. In addition, the access terminal includes means for transmitting the at least one subpacket at the second T2P ratio utilizing a reverse link.

Another aspect of the present disclosure provides an access terminal for wireless communication. The access terminal includes at least one processor, a memory operatively coupled to the at least one processor, and a transceiver operatively coupled to the at least one processor and configured to communicate with an access network. The at least one processor includes various components such as first, second, and third components. The first component is configured to determine a first traffic-to-pilot (T2P) ratio after a session negotiation. The second component is configured to determine a second T2P ratio of at least one subpacket of a packet, wherein the second T2P ratio is boosted relative to the first T2P ratio. The third component is configured to transmit the at least one subpacket at the second T2P ratio utilizing a reverse link.

Another aspect of the present disclosure provides a computer-readable medium including code for causing an access terminal in wireless communication with an access network, to perform various functions. The code configures a first component of the access terminal to determine a first traffic-to-pilot power (T2P) ratio in accordance with a reverse link pilot channel power. The code further configures a second component of the access terminal to determine a second T2P ratio of at least one subpacket of a packet, wherein the second T2P ratio is boosted relative to the first T2P ratio. In addition, the code configures a third component of the access terminal to transmit the at least one subpacket at the second T2P ratio utilizing a reverse link.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### DRAWINGS

FIG. 1 is a block diagram illustrating an example of a network environment in which one or more aspects of the present disclosure may find application.

FIG. 2 is a block diagram illustrating an example of a protocol stack architecture, which may be implemented by an access terminal.

FIG. 3 is a conceptual diagram illustrating an example of EV-DO reverse link frame structure and an interlaced subpacket transmission mechanism.

FIG. 4 is a table illustrating some examples of termination targets of different reverse link payload sizes.

FIG. 5 is a conceptual diagram illustrating an access terminal in communication with an access network in accordance with an aspect of the disclosure.

FIG. 6 is a flowchart illustrating a method of reducing round trip time delay of reverse link transmissions in accordance with an aspect of the disclosure.

FIG. 7 is a flowchart illustrating a method of maintaining a reverse link transmission power level setpoint in accordance with an aspect of the disclosure.

FIG. 8 is a conceptual diagram illustrating an example of a hardware implementation for an apparatus employing a processing system in accordance with an aspect of the disclosure.

FIG. 9 is a conceptual diagram illustrating a software executable at an access terminal to reduce round trip time delay of reverse link transmissions in accordance with an aspect of the disclosure.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

Various aspects of the present disclosure relate to reverse link (uplink) packet transmission improvement. For example, the various concepts of the disclosure can improve or reduce the round trip time (RTT) delay of reverse link packets targeted with two or more sub-packet termination (e.g., 3 or 4 sub-packet termination). The various concepts presented throughout this disclosure may be implemented across a broad variety of wireless communication systems, network architectures, and communication standards. Certain aspects of the discussions are described below for CDMA2000 and 3GPP2 EV-DO protocols and systems, and related terminology may be found in much of the following description. However, the present disclosure is not limited to CDMA2000 or EV-DO, and those of ordinary skill in the art will recognize that one or more aspects of the present disclosure may be employed and included in one or more other wireless communication protocols and systems.

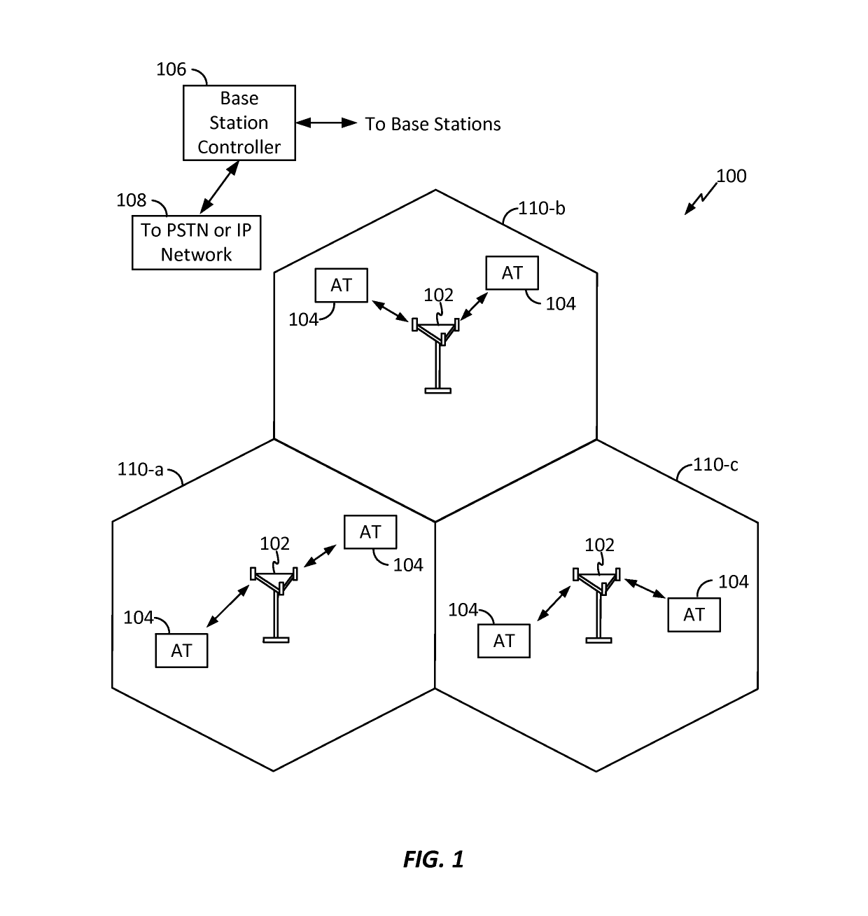

FIG. 1 is a block diagram illustrating an example of a network environment in which one or more aspects of the present disclosure may find application. The wireless communication system 100 generally includes one or more base stations 102, one or more access terminals 104, one or more base station controllers (BSC) 106, and a core network 108 providing access to a public switched telephone network (PSTN) (e.g., via a mobile switching center/visitor location register (MSC/VLR)) and/or to an IP network (e.g., via a packet data switching node (PDSN)). An access network (AN) generally includes a number of base stations 102 and base station controllers 106. The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data (e.g., user traffic data), etc.

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. A base station 102 may also be referred to by those skilled in the art as an access point, a base transceiver station (BTS), a radio base station, a radio transceiver, a transceiver function, a basic service set (BSS), an extended service set (ESS), a Node B, a femto cell, a pico cell, and/or some other suitable terminology.

The base stations 102 are configured to communicate with the access terminals 104 under the control of the base station controller 106 via multiple carriers. Each of the base stations 102 can provide communication coverage for a certain geographic area. The coverage area 110 for each base station 102 here is identified as cells 110-a, 110-b, or 110-c. The coverage area 110 for a base station 102 may be divided into sectors (not shown, but making up only a portion of the coverage area). In a coverage area 110 that is divided into sectors, the multiple sectors within a coverage area 110 can be covered by groups of antennas with each antenna responsible for communication with one or more access terminals 104 in a portion of the cell.

One or more access terminals 104 may be dispersed throughout the coverage area 110, and may wirelessly communicate with one or more cells or sectors associated with each respective base station 102. An access terminal (AT) 104 may generally include one or more devices or components that communicate with one or more other devices through wireless signals. The access terminals 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. Examples of access terminals 104 include mobile phones, smartphones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, connected devices, and/or other, communication/computing devices which communicate, at least partially, through a wireless or cellular network.

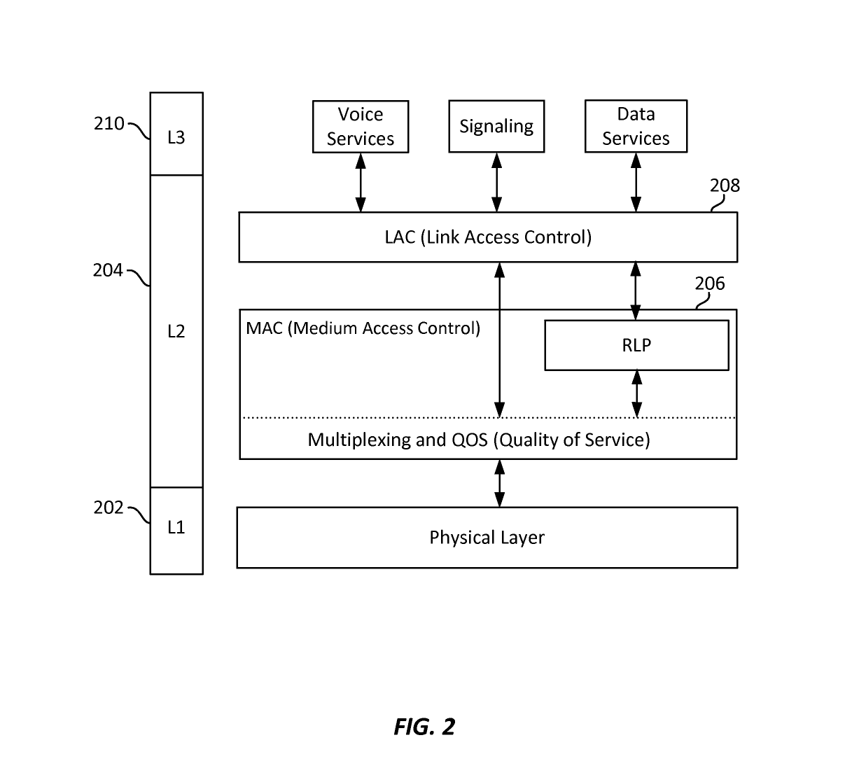

The AT 104 may be adapted to employ a protocol stack architecture for communicating data between the AT 104 and one or more network nodes (e.g., the base station 102) of the wireless communication system 100. A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 2 is a block diagram illustrating an example of a protocol stack architecture which may be implemented by an AT 104. Referring to FIGS. 1 and 2, the protocol stack architecture for the AT 104 is shown to generally include three layers: Layer 1 (L1), Layer 2 (L2), and Layer 3 (L3).

Layer 1 202 is the lowest layer and implements various physical layer signal processing functions. Layer 1 202 is also referred to herein as the physical layer 202. This physical layer 202 provides for the transmission and reception of radio signals between the AT 104 and a base station 102. A data packet exchanged between Layer 1 peer entities may be referred to as a physical layer packet.

The data link layer, called layer 2 (or “the L2 layer”) 204 is above the physical layer 202 and is responsible for delivery of signaling messages generated by Layer 3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of higher layers' protocol data units using the services provided by the physical layer 202. The MAC sublayer 206 may manage the access of data from the higher layers to the shared air interface.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and the access terminal 104. The L3 layer 210 makes use of the services provided by the L2 layer. Information (both data and voice) message are also passed through the L3 layer 210.

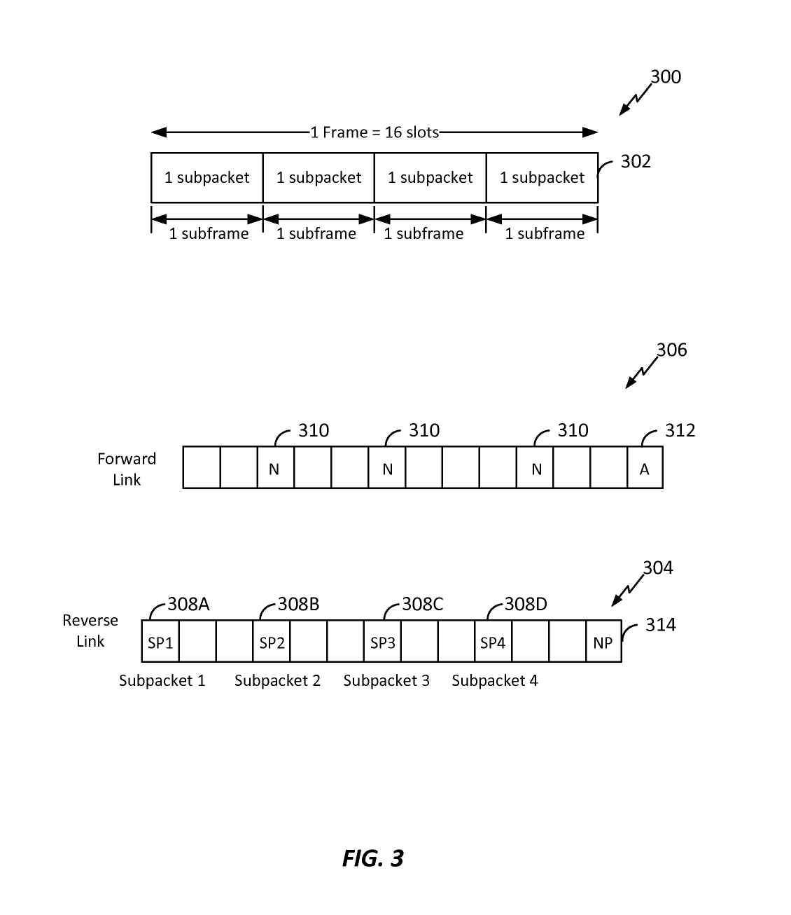

FIG. 3 a conceptual diagram illustrating an example of EV-DO reverse link (RL) frame structure 300 and an interlaced subpacket transmission mechanism. In EV-DO, an RL frame has sixteen slots that are divided into four subframes. Each subframe takes up four slots and may be used to transmit one subpacket. A subpacket 302 is the smallest unit of a reverse channel transmission that can be acknowledged at the physical layer by an access network. A subpacket 302 is transmitted over four contiguous slots, thus a subpacket is transmitted in one subframe. Each physical layer packet can be transmitted in one and up to four subpackets. Code division multiplexing is used to simultaneously transmit multiple channels in the reverse link. For example, the RL channels may include a Reverse Rate Indicator (RRI) channel, a data channel, a Data Rate Control (DRC) channel, an Acknowledgment channel, a Data Source Channel, and a pilot channel. The Acknowledgment channel and Data Source Channel are time-multiplexed together.

At the physical layer (Layer 1), current implementations of EV-DO wireless networks implement an error-detection-and-correction scheme known as HARQ, which increases data reliability by enabling retransmissions of failed packets (or retransmission of portions of those packets). The reverse link packet transmissions are staggered in time and interlaced, to provide the access network with time to demodulate and decode the packets and then transmit an acknowledgement to an AT, indicating whether or not the transmitted packet was successfully decoded. In EV-DO, for example, an AT 104 can send a reverse link physical layer packet to a base station 102 as a number of subpackets (e.g., one physical layer packet may be divided into four subpackets). Each physical layer packet has redundancy so that it is possible for the access network to decode the entire physical layer packet without receiving all the subpackets (e.g., decoded using only one or two subpackets). For each subpacket transmission of the physical layer packet, the base station 102 responds to the AT 104 with either an acknowledgment (ACK) (indicating successful receipt/decoding) or a negative acknowledgement (NACK) (indicating failure to successfully receive/decode).

FIG. 3, for example, also illustrates a HARQ mechanism with a reverse link 304 and a forward link 306. The AT 104 may send a physical layer packet through the reverse link 304 using one or more four-slot subpackets (e.g., 308A, 308B, 308C, and 308D) up to four subpackets. Each of these subpacket transmissions can also be referred to as a transmission attempt of the physical layer packet. The subpackets of different physical layer packets are interlaced. For example, there are eight time slots between successive transmissions of the subpackets (e.g., 308A and 308B) of the same physical layer packet, and these time slots can be used for transmitting other packets. In FIG. 3, there are a total of three interlaces. In this example, a base station 102 respectively transmits three NAK responses 310 on the forward link 306 after the first three subpackets (308A, 308B, and 308C) are transmitted by an AT 104. After the fourth subpacket 308D is transmitted, the base station transmits an ACK 312 indicating that the packet is successfully received, and the AT 104 may transmit the first subpacket 314 of the next physical layer packet.

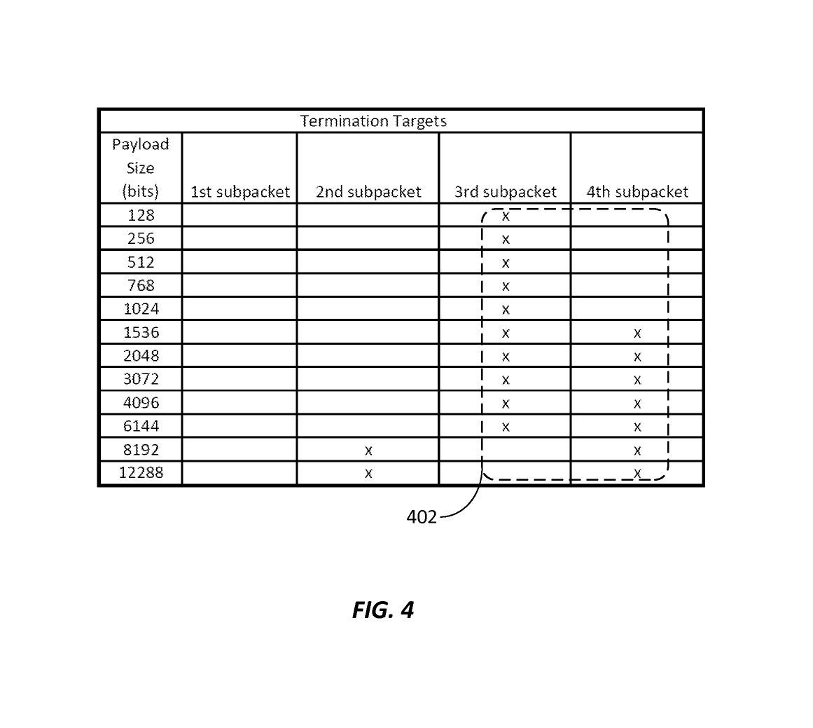

In another example, if the AT 104 receives an ACK from the base station 102 in response to, for example, the first, second, or third subpacket (e.g., subpackets 308A, 308B, or 308C) transmitted to the base station 102, the AT 104 will not proceed with additional subpackets or attempts (i.e., early termination). Therefore, the AT 104 can use the next time slot for the first subpacket or attempt of the next physical layer packet. In general, in this four-slot interlacing structure, transmit slots on the reverse link 304 and ACK/NACK slots on the forward link 306 are offset so that the AT 104 can determine how to use the next transmit slot upon receipt of an ACK or NACK. The early termination of a four-subpacket cycle upon receipt of an ACK increases overall throughput (i.e., effective data rate) on the reverse link 304 as compared with a scheme that would always use all four subpackets or attempts for every physical layer packet. FIG. 4 is a table illustrating some examples of termination targets for different reverse link payload sizes. The reverse link packet transmissions are frequently targeted with 3 or 4 subpacket termination 402 as shown in the table of FIG. 4. Due to the interlaced reverse link frame structure, this can lead to undesirably long round trip time (RTT) delay. The RTT represents the end-to-end round trip delay between hosts or nodes.

In EV-DO RL, the pilot channel is used for channel estimation of the air interface between the base station and the AT, and is used for power control purposes. Transmission power of the other channels (e.g., traffic channel) are defined by channel gains with respect to the pilot channel. For an RL traffic channel (e.g., reverse link 304), its transmit power is specified by a power gain called the traffic-to-pilot power (T2P) ratio.

In accordance with aspects of the present disclosure, an AT 104 can reduce RTT delay by boosting the T2P ratio by a suitable amount, such that an RL packet will be more likely to be early terminated at its first or second subpacket or attempt. In a non-limiting example, the AT 104 may boost the T2P ratio by about 8 dB. Here, the RL transmit power of the AT 104 is based on the T2P ratio, which is generally provided to the AT 104 by the base station 102. Boosting the T2P ratio can reduce the RTT and improve user experience.

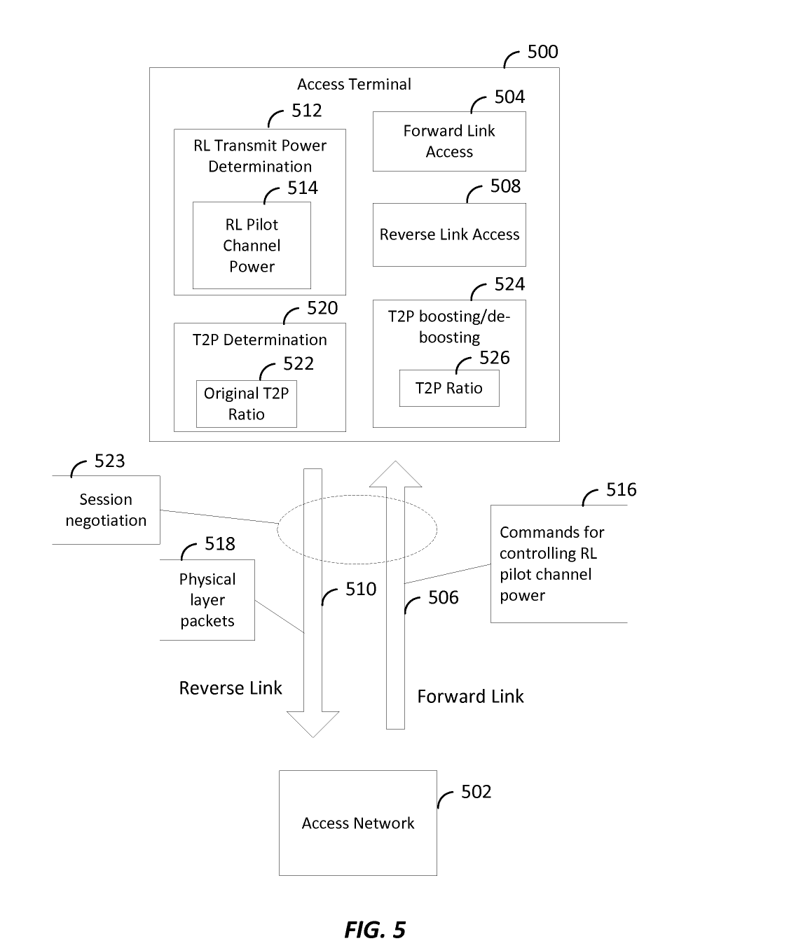

FIG. 5 is a conceptual diagram illustrating an AT 500 in communication with an access network (AN) 502 in accordance with an aspect of the disclosure. For example, the AT 500 may be any of the ATs illustrated in FIGS. 1, 5, and/or 8 such as an AT 104 of FIG. 1. The access network 502 may include a number of base stations 102 and base station controller 106 such as those illustrated in FIG. 1.

The AT 500 includes various components that may be implemented in software, firmware, hardware, or any combinations thereof. The AT 500 includes a forward link access component 504 for receiving data from the access network 502 through a forward link 506. The AT 500 also includes a reverse link access component 508 for transmitting data to the access network 502 through a reverse link 510. For example, the reverse link 510 may include an EV-DO reverse traffic channel such as the reverse link 304 of FIG. 3. In addition, the AT 500 includes a reverse link (RL) transmit power determination component 512 for determining the transmission power level of physical layer packets 518 transmitted on the reverse link 510. For example, the RL transmit power determination component 512 may determine an RL pilot channel power 514 that is controlled by one or more commands 516 received from the access network 502. For the RL traffic channel, its power is specified by the power gain T2P ratio. Depending on the targeted attempts (i.e., number of subpacket transmissions), a physical layer packet 518 may be transmitted as one or more interlaced subpackets such as subpackets 308A, 308B, 308C, and 308D of FIG. 3.

Each of the commands 516 instructs the AT 500 to increase or decrease the RL pilot channel power 514 based on, for example, network conditions measured by the access network 502. The AT 500 includes a T2P determination component 520 for determining a T2P ratio 522 (original T2P ratio) for a reverse link subpacket after a session negotiation 523 between the AT 500 and access network 502. The T2P ratio 522 controls the transmission power level of the subpacket as a power gain over the RL pilot channel power 514.

The AT 500 further includes a T2P boosting/de-boosting component 524 that can boost (increase) or de-boost (decrease) the T2P ratio 522 of a subpacket by a suitable amount to arrive at a different T2P ratio 526. For example, when the AT 500 boosts the T2P ratio of a first subpacket of a physical layer packet, the transmission of this physical layer packet is more likely to be early terminated at the first subpacket or attempt. In other words, the AT 500 may transmit a subpacket at a T2P ratio 526 that is different from the original (unboosted) T2P ratio 522 that is determined after a session negotiation between the AT 500 and access network 502. In EV-DO, for example, a session negotiation is the process that allows the AT and access network to agree on a set of protocols and parameters (e.g., T2P ratio) to use. In an aspect of the disclosure, if a subpacket of a physical layer packet is transmitted at a boosted T2P ratio 526, the T2P boosting/de-boosting component 524 may de-boost (decrease) the T2P ratios of other subpackets of the same physical layer packet. Therefore, the AT 500 may maintain a reverse link transmission power level setpoint (e.g., E_{b}/Nₜ, where E_{b} is the average bit energy, Nₜ refers to the total noise) for the physical layer packet.

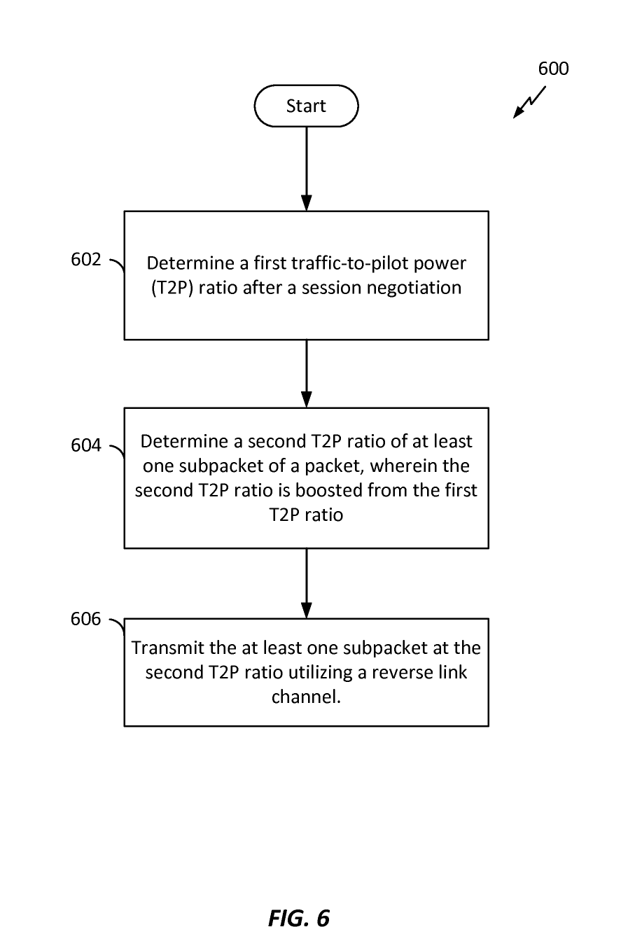

FIG. 6 is a flowchart illustrating a method 600 of reducing RTT delay of reverse link transmissions in accordance with an aspect of the disclosure. For example, the method 600 may be performed by any of the ATs illustrated in FIGS. 1, 5, and/or 8 such as the AT 500 of FIG. 5. At block 602, the AT 500 determines a first T2P ratio after a session negotiation between the AT 500 and access network 502. The RL pilot channel power 514 may be controlled by one or more commands 516 received from an access network 502. For example, the AT 500 may utilize the RL transmit power determination component 512 to determine the RL pilot channel power 514. Here, the access network 502 transmits the commands 516 to the AT 500 utilizing the forward link 506. At block 604, the AT 500 determines a second T2P ratio of at least one subpacket of a packet. The second T2P ratio may be boosted relative to the first T2P ratio. The first T2P ratio (i.e., original T2P ratio or non-boosted T2P ratio) is determined after session negotiation between the AT 500 and the access network 502. In one example, the AT 500 may utilize the T2P determination component 520 to determine an original T2P ratio 522 for transmitting a subpacket, for example, a subpacket 308A of FIG. 3. In this example, the corresponding physical layer packet may have a termination target of 3 or more subpackets. In order to increase the likelihood that the packet may be terminated early, the AT 500 may utilize the T2P boosting/deboosting component 524 to increase (boost) the T2P ratio of the first subpacket from the original T2P ratio 522 to a boosted T2P ratio 526. At block 606, the AT 500 transmits the at least one subpacket at the second T2P ratio 526 utilizing a reverse link 510. In one example, the reverse link 510 may include an EV-DO reverse link traffic channel. In other examples, the second T2P ratio 526 may be the same or different (e.g., boosted) from the first T2P ratio 522 based on a load condition of the reverse link channel.

In one aspect of the disclosure, when the second T2P ratio 526 is greater than the first T2P ratio 522, the transmission of the physical layer packet is more likely to be terminated early at the first subpacket; hence the RTT delay may be reduced and RL throughput may be increased. In another aspect of the disclosure, the second T2P ratio 526 is equal to (i.e., no boosting) the first T2P ratio 522 if the filtered transmission (Tx) power is high and/or the load condition of the reverse link is heavy. For example, the filtered Tx power is an average of the AT's Tx power. The Tx power may be considered high when the AT's Tx power is a certain dBs below the AT's maximum Tx power. The load condition of the reverse link may be heavy when the uplink load exceeds a certain threshold. In these conditions, boosting the T2P ratio will undesirably cause more load and/or interference on the reverse link.

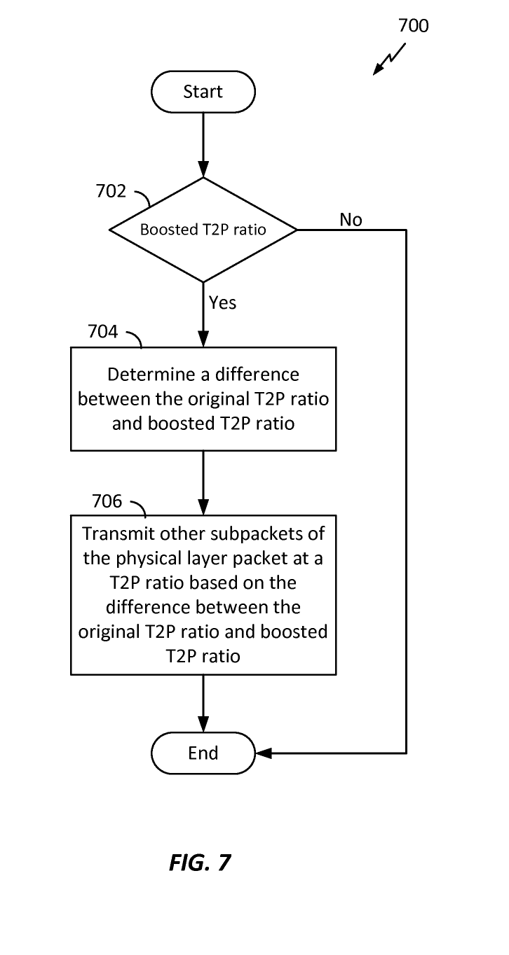

In an aspect of the disclosure, the AT 500 maintains the reverse link transmission power level setpoint based on a difference between an original T2P ratio (e.g., the first T2P ratio 522) and a boosted T2P ratio (e.g., the second T2P ratio 526). FIG. 7 is a flowchart illustrating a method 700 of maintaining a reverse link transmission power level setpoint in accordance with an aspect of the disclosure. For example, the method 700 may be performed by any of the ATs illustrated in FIGS. 1, 5, and/or 8, for example, the AT 500 of FIG. 5. The method 700 may be performed after a first subpacket has been transmitted. In one example, it can be assumed that a first subpacket (e.g., subpacket 308A) is transmitted at a boosted T2P ratio in accordance with the method 600. At block 702, if a first subpacket is transmitted at a boosted T2P ratio, the method continues to block 704; otherwise, the method ends. For example, the T2P ratio of the first subpacket may be boosted (increased) from a first T2P ratio 522 (original T2P ratio) to a second T2P ratio 526 (boosted T2P ratio), wherein the original T2P ratio is determined after a session negotiation between the AT and access network.

At block 704, the AT 500 determines a difference between the original T2P ratio and boosted T2P ratio. For example, the boosted T2P ratio may be greater than the original T2P ratio by 8 decibel (dB) or a suitable amount. At block 706, the AT 500 transmits other subpackets of the physical layer packet at a T2P ratio based on a difference between the original T2P ratio and boosted T2P ratio. For example, the AT 500 may transmit other subpackets at a T2P ratio that is less than the boosted T2P ratio and/or the original T2P ratio by a suitable amount. Therefore, the reverse link transmission power level setpoint may be maintained. That is, the AT 500 may de-boost the T2P ratio of the other subpackets by an amount that is determined based on the boosted amount of the first subpacket. In one example, the AT 500 may de-boost the T2P ratio of one or more of the other subpackets by 4 dB. The boosted amount refers to the difference between the original T2P ratio and boosted T2P ratio of the first subpacket. In one example, the AT 500 may transmit other subpackets (e.g. subpackets 308B, 308C, and/or 308D) of the physical layer packet at a T2P ratio that is less than the original T2P ratio.

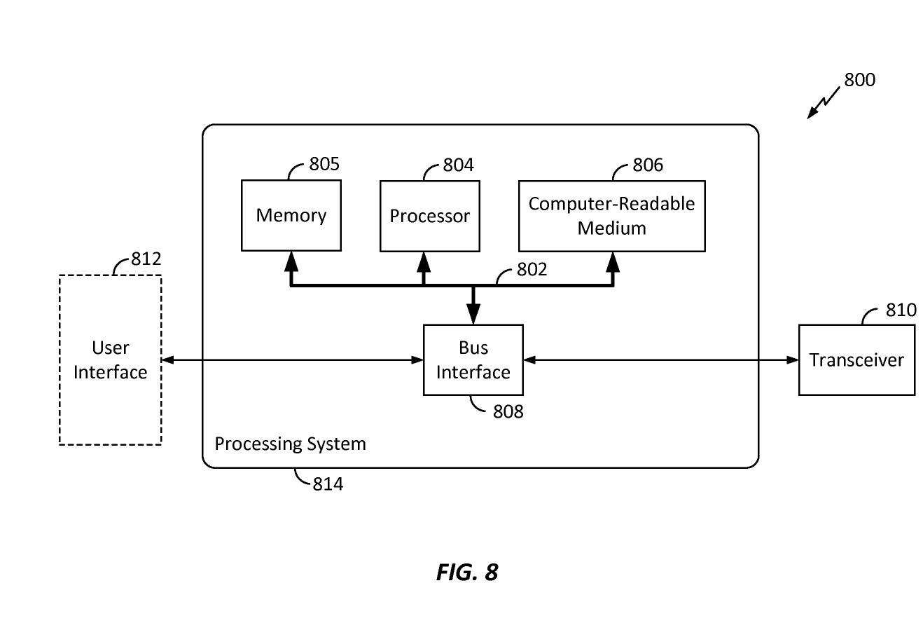

FIG. 8 is a conceptual diagram illustrating an example of a hardware implementation for an apparatus 800 employing a processing system 814. In accordance with various aspects of the disclosure, an element, or any portion of an element, or any combination of elements may be implemented with a processing system 814 that includes one or more processors 804. For example, the apparatus 800 may be any of the ATs illustrated in FIGS. 1 and/or 5, for example, an AT 500. In one aspect of the disclosure, the apparatus 800 may be used to implement the components of the AT 500 described and illustrated in FIG. 5. In another example, the apparatus 800 may be a base station as illustrated in FIGS. 1 and/or 5. Examples of processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 804, as utilized in an apparatus 800, may be used to implement any one or more of the processes, procedures, methods, or algorithms described and illustrated in FIGS. 5-7.

In this example, the processing system 814 may be implemented with a bus architecture, represented generally by the bus 802. The bus 802 may include any number of interconnecting buses and bridges depending on the specific application of the processing system 814 and the overall design constraints. The bus 802 links together various circuits including one or more processors (represented generally by the processor 804), a memory 805, and computer-readable media (represented generally by the computer-readable medium 806). The bus 802 may also link various other circuits such as timing sources, peripherals, voltage regulators, and power management circuits, which are well known in the art, and therefore, will not be described any further. A bus interface 808 provides an interface between the bus 802 and a transceiver 810. The transceiver 810 provides a means for communicating with various other apparatus over a transmission medium. For example, the transceiver 810 may be configured to support various communication protocols such as EV-DO. Depending upon the nature of the apparatus, a user interface 812 (e.g., keypad, display, speaker, microphone, joystick, touch screen, touchpad, etc.) may also be provided.

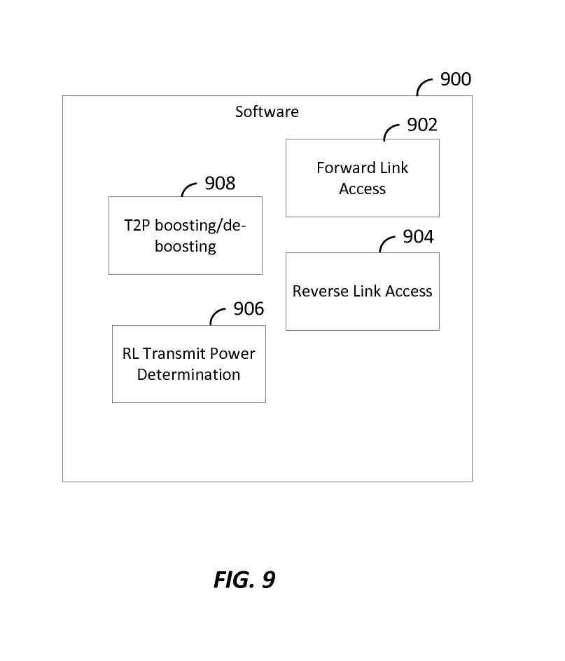

The processor 804 is responsible for managing the bus 802 and general processing, including the execution of software stored on the computer-readable medium 806. Referring to FIG. 9, for example, software 900, when executed by the processor 804, causes the processing system 814 to perform the various functions described in FIGS. 4-7, for any particular apparatus. The software 900 may include a forward link access routine 902 for configuring and controlling how the AT 800 communicates with an access network 502 using a forward link 506. The software 900 may include a reverse link access routine 904 for configuring and controlling how the AT 800 communicates with an access network 502 using a reverse link 510. A reverse link transmit power determination routine 906 may be utilized to configure and control how the AT 800 determines reverse link transmit power such as the original T2P ratio of a subpacket. For example, the subpacket may be any of the subpackets 308A, 308B, 308C, and/or 308D of FIG. 3. The software may also include a T2P boosting/de-boosting routine 908 for configuring and controlling how the AT 800 boosts or de-boosts the original T2P ratio of a subpacket. Referring back to FIG. 8, the computer-readable medium 806 may also be used for storing data that is manipulated by the processor 804 when executing software.

One or more processors 804 in the processing system may execute software, for example, software 900. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 806. The computer-readable medium 806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 806 may reside in the processing system 814, external to the processing system 814, or distributed across multiple entities including the processing system 814. The computer-readable medium 806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

Several aspects of a telecommunications system have been presented with reference to an EV-DO system. As those skilled in the art will readily appreciate, various aspects described throughout this disclosure may be extended to other telecommunication systems, network architectures and communication standards.

By way of example, various aspects may be extended to UMTS systems such as W-CDMA, TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods, procedures, or algorithms disclosed is an illustration of exemplary processes. Based upon design preferences, it is understood that the specific order or hierarchy of steps in the methods, procedures, or algorithms may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at an access terminal, comprising:
determining a first traffic-to-pilot power (T2P) ratio after a session negotiation;
determining a second T2P ratio of at least one subpacket of a packet, wherein the second T2P ratio is boosted relative to the first T2P ratio; and
transmitting the at least one subpacket at the second T2P ratio utilizing a reverse link.

2. The method of claim 1, further comprising:
transmitting other subpackets of the packet at a third T2P ratio that is less than the first T2P ratio.

3. The method of claim 1, further comprising:
maintaining a reverse link transmission power level setpoint based on a difference between the first T2P ratio and second T2P ratio.

4. The method of claim 1, wherein the second T2P ratio is greater than the first T2P ratio by a first amount,
the method further comprising:
transmitting other subpackets of the packet at a third T2P ratio that is less than the first T2P ratio by a second amount that is determined based on the first amount.

5. The method of claim 1, further comprising:
setting the second T2P ratio to be equal to or greater than the first T2P ratio based on at least one of a load condition of the reverse link or a filtered transmission power of the access terminal.

6. The method of claim 1, wherein the packet has a termination target of three or more subpackets.

7. The method of claim 1, wherein the reverse link comprises an EV-DO reverse link traffic channel.

8. An access terminal, comprising:
means for determining a first traffic-to-pilot power (T2P) ratio after a session negotiation;
means for determining a second T2P ratio of least one subpacket of a packet, wherein the second T2P ratio is boosted relative to the first T2P ratio; and
means for transmitting the at least one subpacket at the second T2P ratio utilizing a reverse link.

9. The access terminal of claim 8, further comprising:
means for transmitting other subpackets of the packet at a third T2P ratio that is less than the first T2P ratio.

10. The access terminal of claim 8, further comprising:
means for maintaining a reverse link transmission power level setpoint based on a difference between the first T2P ratio and second T2P ratio.

11. The access terminal of claim 8, wherein the second T2P ratio is greater than the first T2P ratio by a first amount, further comprising:
means for transmitting other subpackets of the packet at a third T2P ratio that is less than the first T2P ratio by a second amount that is determined based on the first amount.

12. The access terminal of claim 8, further comprising:
means for setting the second T2P ratio to be equal to or greater than the first T2P ratio based on at least one of a load condition of the reverse link or a filtered transmission power of the access terminal.

13. The access terminal of claim 8, wherein the packet has a termination target of three or more subpackets.

14. The access terminal of claim 8, wherein the reverse link comprises an EV-DO reverse link traffic channel.

15. An access terminal comprising:
at least one processor;
a memory operatively coupled to the at least one processor; and
a transceiver operatively coupled to the at least one processor and configured to communicate with an access network,
wherein the at least one processor comprises:
a first component configured to determine a first traffic-to-pilot (T2P) ratio after a session negotiation;
a second component configured to determine a second T2P ratio of at least one subpacket of a packet, wherein the second T2P ratio is boosted relative to the first T2P ratio; and
a third component configured to transmit the at least one subpacket at the second T2P ratio utilizing a reverse link.

16. The access terminal of claim 15, wherein the at least one processor further comprises:
a fourth component configured to transmit other subpackets of the packet at a third T2P ratio that is less than the first T2P ratio.

17. The access terminal of claim 15, wherein the at least one processor further comprises:
a fourth component configured to maintain a reverse link transmission power level setpoint based on a difference between the first T2P ratio and second T2P ratio.

18. The access terminal of claim 15, wherein the second T2P ratio is greater than the first T2P ratio by a first amount, and
the at least one processor further comprises:
a fourth component configured to transmit other subpackets of the packet at a third T2P ratio that is less than the first T2P ratio by a second amount that is determined based on the first amount.

19. The access terminal of claim 15, wherein the at least one processor further comprises:
a fourth component configured to set the second T2P ratio to be equal to or greater than the first T2P ratio based on at least one of a load condition of the reverse link or a filtered transmission power of the access terminal.

20. The access terminal of claim 15, wherein the packet has a termination target of three or more subpackets.

21. The access terminal of claim 15, wherein the reverse link comprises an EV-DO reverse link traffic channel.

22. A computer-readable medium comprising code for causing an access terminal in wireless communication with an access network, to:
configure a first component of the access terminal to determine a first traffic-to-pilot power (T2P) ratio after a session negotiation;
configure a second component of the access terminal to determine a second T2P ratio of at least one subpacket of a packet, wherein the second T2P ratio is boosted relative to the first T2P ratio; and
configure a third component of the access terminal to transmit the at least one subpacket at the second T2P ratio utilizing a reverse link.

23. The computer-readable medium of claim 22, wherein the code further causes the access terminal to:
configure a fourth component of the access terminal to transmit other subpackets of the packet at a third T2P ratio that is less than the first T2P ratio.

24. The computer-readable medium of claim 22, wherein the code further causes the access terminal to:
configure a fourth component of the access terminal to maintain a reverse link transmission power level setpoint based on a difference between the first T2P ratio and second T2P ratio.

25. The computer-readable medium of claim 22, wherein the second T2P ratio is greater than the first T2P ratio by a first amount, and
the code further causes the access terminal to:
configure a fourth component of the access terminal to transmit other subpackets of the packet at a third T2P ratio that is less than the first T2P ratio by a second amount that is determined based on the first amount.

26. The computer-readable medium of claim 22, wherein the code further causes the access terminal to:
configure a fourth component of the access terminal to set the second T2P ratio to be equal to or greater than the first T2P ratio based on at least one of a load condition of the reverse link or a filtered transmission power of the access terminal.

27. The computer-readable medium of claim 22, wherein the packet has a termination target of three or more subpackets.

28. The computer-readable medium of claim 22, wherein the reverse link comprises an EV-DO reverse link traffic channel.
